(19) United States
(12) Patent Application Publication
(10) Pub. No.: US 2005/0088510 A1
(43) Pub. Date: Apr. 28, 2005

(54) Low angle optics and reversed optics

(76) Inventors: Shlomo Assa, Carlsbad, CA (US); Matthew Smith, San Diego, CA (US)

Correspondence Address: FISH & RICHARDSON, PC, 12390 EL CAMINO REAL, SAN DIEGO, CA, 92130-2081, US

(21) Appl. No.: 10/693,356

(22) Filed: Oct. 24, 2003

(51) Int. Cl. B41J 27/00

(52) U.S. Cl. 347/243

(57) ABSTRACT

A printing system for printing a code on a product or product packaging. The printing system includes a laser source for producing a printing beam and at least two mirrors to direct the printing beam to a plurality of locations on a material.

### BACKGROUND

Modem production practices often involve printing an identification code on commercial products. These codes are easily observed on common products such as soda cans, cosmetics pet food container, etc. Some government regulatory agencies, such as the Food and Drug Administration may require certain products to have such codes.

These codes often include information that is unique to the time and place at which the product is manufactured. For instance, many codes communicate a batch number associated with a product. Many codes go further and indicate the actual time and date of manufacture. Because some codes relate to unique manufacturing parameters (e.g., time and date), some codes cannot be pre-printed on a label for a product. Hence, a code is often printed on the label after the product is manufactured. Current code printing technology includes the use of ink jets, which spray ink onto the label.

### SUMMARY

The present application relates to a printing system that uses a laser and an optics assembly, such as mirrors, to print a code on a product. The optics assembly in the printing system includes low angle optics and reversed optics. The optics assembly directs a printing beam from the laser to a plurality of locations on the product. The optics assembly may allow the printing system to use a larger laser beam diameter and a smaller spot size. The optics assembly may provide more working room on one or more mirrors in the optics assembly, i.e., more room or tolerance for alignment errors, for a given laser beam diameter size. The optics assembly may use a smaller mirror.

Smaller mirrors in the printing system may have several advantages. Smaller mirrors need less material and may be less expensive to manufacture. Smaller mirrors may be easier and faster to tilt in the optics assembly. Larger mirrors have greater inertia and require more torque to move than smaller mirrors. The printing system may use smaller, less complex components, such as actuators or micromotors, to move smaller mirrors. Smaller mirrors may fit in a smaller space of the printing system and allow the overall size of the printing system to be smaller.

An aspect of the application relates to a method for printing a spot on an object. The method comprises reflecting an incident light beam by a starting angle of less than ninety degrees to form a first reflected light beam; varying the starting angle of reflection of the first reflected light beam by a pre-determined amount; reflecting the first reflected light beam to form a second reflected beam; varying an angle of reflection of the second reflected light beam; and directing the second reflected beam to form a spot on an object.

Another aspect of the application relates to system comprising a first mirror, a first actuator, a second mirror, a second actuator and a controller. The first actuator is attached to the first mirror. The second actuator is attached to the second mirror. The controller is coupled to the first and second actuators. The controller controls the first actuator to cause the first mirror to reflect an incident light beam by a starting angle of less than ninety degrees to form a first reflected light beam. The first actuator is operable to tilt the first mirror and vary the starting angle of reflection of the first reflected light beam by a pre-determined amount. The controller controls the second actuator to cause the second mirror to reflect the first reflected light beam to form a second reflected beam. The second mirror directs the second reflected beam to form a spot on an object. The second actuator is operable to tilt the second mirror and vary an angle of reflection of the second reflected light beam by a predetermined amount.

Details one or more implementations are set forth in the accompanying drawings and the description below. Other features and advantages may be apparent from the description, drawings and/or claims.

### BRIEF DESCRIPTION OF THE DRAWINGS

FIG. 1A is a side view of a printing system.

FIG. 1B is a cross-section of the printing system of FIG. 1A looking down on to the printing system.

FIG. 2 illustrates the printing system of FIG. 1A forming a print zone upon a product.

FIG. 3A is a side view of a printing system used in conjunction with a product line which temporarily stops a product in front of the printing system.

FIG. 3B is a side view of a printing system used in conjunction with a product line which continuously moves a product in front of the printing system.

FIG. 3C is a top view of the printing system of FIG. 3B used in conjunction with a product line which continuously moves the product in front of the printing system.

FIG. 4A illustrates an optical assembly for use in the printing system of FIG. 1A.

FIG. 4B is a side view of a plurality of mirrors of FIG. 4A configured to steer a printing beam produced by the printing system from one location to another on a product where a code is to be formed.

FIG. 4C illustrates the relationship between an optics assembly and a housing of the printing system of FIG. 4A.

FIG. 4D illustrates the non-linear nature of a lens used in the optics assembly of FIG. 4A.

FIG. 4E illustrates a bearing of FIG. 4B which allows a printing beam exit member of the printing system to be rotated relative to a housing of the printing system.

FIGS. 4F and 4G illustrate another configuration of the mirrors in FIG. 4B.

FIG. 5 illustrates a mirror, which represents each mirror in FIG. 4B.

FIG. 6 illustrates a mirror, which represents a variation of at least one of the mirrors in FIG. 4B.

FIG. 7 illustrates an example of a tilted circular mirror (representing one of the mirrors in FIG. 4B) with a diameter D and a circular light beam with a diameter DX.

FIG. 8 illustrates a graph of a minor axis length (FIG. 7) versus the 30-degree and 45-degree angles between the surface normal and the reflected beams in FIGS. 5 and 6, respectively.

FIG. 9A illustrates an example of a printed image with a second mirror that controls y-direction scanning.

FIG. 9B illustrates an example of a printed image with a second mirror that controls x-direction scanning.

FIG. 10A is a side view of a printing beam being incident on a material at a location where a spot is to be formed on the material.

FIG. 10B is a perspective view of a printing beam being incident on a material at a location where a spot is to be formed on the material.

FIG. 10C is a side view of a material after the printing beam has formed a spot in the material.

FIG. 10D is a perspective view of a material after the printing beam has formed a spot in the material.

FIGS. 11A-11D illustrate formation of pixels having different sizes.

FIG. 12A illustrates an array of possible pixels which are selected to form a symbol within the array.

FIG. 12B illustrates the symbol of FIG. 7A printed on a product.

### DETAILED DESCRIPTION

The printing system described below may print spots on a product at various locations. The spots may be arranged to form a pixel on the product. The pixels in turn can be arranged to form a symbol of a code.
spots→pixels→symbols→code

The symbols of the code can be symbols which are available in word processing programs, such as alphanumeric symbols and any other symbols used to identify a product batch, date, etc. The code can be readable text such as product names or identifiers. The code need not be alphanumeric and can include symbols which are not produced by typical word processing programs. For instance, the code can be a bar code.

The products for use with the printing system can be products to be sold retail or packaging of retail products. Further, the products can be products which are sold to other businesses. Examples of products include pharmaceuticals, pharmaceutical packaging, food packaging, cosmetics, food such as eggs, dairy products, ice cream, computer components, automotive components, medical devices, detergents and beverages such as soft drinks and wines.

The code can be formed in multiple locations on a product. For instance, plastic medicine bottles can have one code printed directly on the plastic bottle and another code formed on the label attached to the plastic bottle.

A spot is formed on the product by altering the physical characteristic of the material at the location where the printing beam is incident on the product. The printing beam can alter a variety of physical characteristics of a product. For instance, the printing beam can cause one or more layers of material to be ablated, which exposes the underlying layers. Since upper layers of a material often have an ink layer on paper, removal of the ink layer leaves a spot where the paper is visible against the surrounding ink layer. The refractive characteristics of a material can also be altered. For instance, the printing beam can be used to print a code on a plastic such as a soft drink bottle. The printing beam alters the refractive characteristics of the plastic. The code is easily visible since the eye can pick up the sections having contrasting refractive properties. In addition, the printing beam can etch certain materials.

Since the printing system employs a laser in order to print on the product, there is no need for consumables such as inks and solvents. Accordingly, the printing system can reduce the costs and complexity associated with printing a code on a product.

Traditional printing systems which employ a laser for printing a code on a product typically employ high-powered lasers which often require liquid cooling and large amounts of space. However, in the printing system described below, the time that a laser dwells at each location can be increased to compensate for reductions in the power of the laser. As a result, a low powered laser can be employed in the printing system. For instance, in one configuration, the laser is a CO₂ air-cooled laser. In some instances, the laser is at most a 25 Watt laser, such as a 20 Watt laser, a 15 Watt laser or a 13 Watt laser.

Because the laser can be a low power laser, the laser, optics assembly and associated electronics can be mounted in a housing having a size on the order of an ink jet printer. As a result, the ability to adjust the dwell time means that the printing system overcomes the size and space challenges associated with traditional printing systems which employ a laser. Hence, the printing system described below is an improved substitute for ink jets used to print codes on products.

The printing system may be suitable for printing on products that are moving, such as the products in a production line. Because these products are moving relative to the system, there is a limited amount of time available for printing on each product. The printing system includes electronics for varying the amount of time to print the code on the product. For instance, the printing system includes electronics for changing the density of pixels that define the code. Codes having a reduced pixel density can be printed more quickly than codes with an increased pixel density. Further, the printing system includes electronics for changing the size of the pixels that define the code. Smaller pixels need less printing time. In addition, the dwell time of the printing system can be changed as noted above. The ability to change the time needed to print a code allows the printing system to be used in conjunction with more production lines.

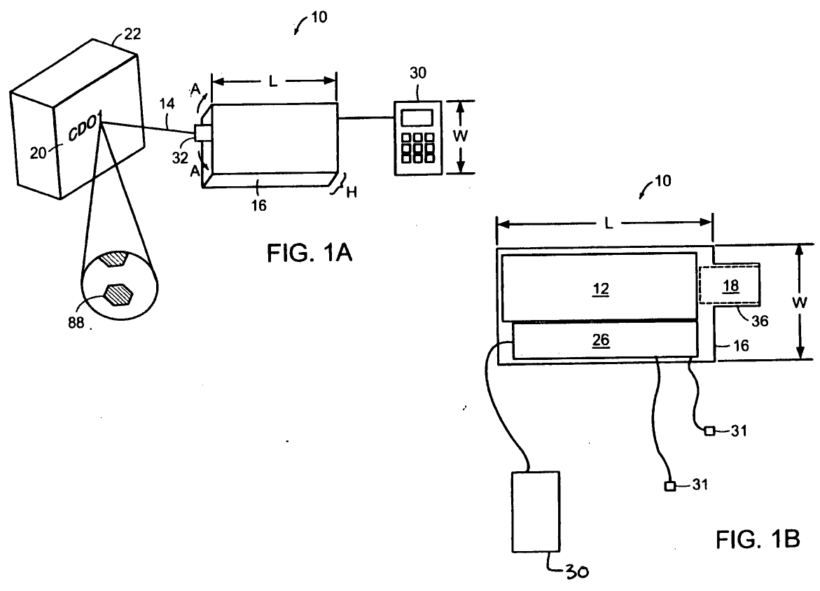

FIGS. 1A and 1B illustrate a printing system 10 for printing on a product 22 positioned adjacent to the printing system 10. FIG. 1A is a side view of the printing system 10, while FIG. 1B is a cross sectional top view of the printing system 10. The printing system 10 includes a laser 12 for producing a printing beam 14. Any laser 12 can be used in the printing system. The printing system 10 includes electronics 26 (FIG. 1B) for adjusting the time that the printing beam 14 dwells at each location. This “dwell time” is adjusted such that the printing beam 14 causes a spot to be formed at each location. Since the dwell time can be increased in order to compensate for the reduced laser power, a low powered laser can be employed in the printing system. For instance, the laser 12 can be a CO₂ air-cooled laser. In some instances, the laser may be a 25-Watt laser, a 20-Watt laser, a 15-Watt laser or a 13-Watt laser.

The printing beam 14 from the laser/energy source 12 passes through an optics assembly 18 and is incident on a material 20, such as the material used in product packaging. As will be described in more detail below, the time that the beam 14 is incident on the material 20 can be adjusted such that the beam 14 causes a spot to be formed on the material 20.

The optics assembly 18 includes components for altering the direction of the printing beam 14. These components can be controlled to steer the printing beam 14 from one location to another location so as to create a spot at each of the locations. As will be described in more detail below, the spots can be arranged to form one or more pixels 88 on the material 20. In addition, these pixels 88 can be arranged to form one or more symbols on the material 20. These symbols can be an alphanumeric code printed on a product 22 or on the label of a product 22.

The printing system 10 also includes electronics 26 in communication with the laser/energy source 12 and the optics assembly 18. The electronics 26 can include one or more processors for providing the functionality to the printing system 10. Suitable processors include, but are not limited to, microprocessors, digital signal processors (DSP), integrated circuits, application specific integrated circuits (ASICs), logic gate arrays and switching arrays. The electronics 26 can also include one or more memories for storing instructions to be carried out by the one or more processors and/or for storing data developed during operation of the printing system 10. Suitable memories include, but are not limited to, RAM and electronic read-only memories (e.g., ROM, EPROM, or EEPROM).

The electronics 26 control the operation of the laser 12 and the optics assembly 18. For instance, the electronics 26 can control the optics assembly 18 to adjust the direction of the printing beam 14, the length of time that the printing beam 14 dwells at a location on the material 20 where a spot is to be formed, the speed that the printing beam 14 moves between each location where the beam dwells, the size of pixels 88 used to create visually recognizable symbols, the selection of symbols created, etc.

The electronics 26 can optionally be in communication with a user interface 30. The user interface 30 can be remote from the housing 16, attached to the housing 16 and/or detachable from the housing 16. A suitable user interface 30 can include an alphanumeric keyboard and a display. The user interface 30 can be used to program the electronics 26 and/or set printing parameters. For instance, the user interface 30 can be used to manually control the time that the printing beam 14 dwells at a single location on the material 20, the size of the pixels 88 used to form a visually observable symbol, the type and/sequence of symbol which are formed, etc. The user interface 30 can also be used to manually activate the printing system 10. For instance, the user interface 30 can include a print key which causes the printing system 10 to print on the material 20.

The electronics 26 can also be in communication with one or more sensors 31. These sensors 31 can provide the electronics 26 with information about the products on which the printing system 10 is to print. For instance, the sensors 31 can indicate the location of a product 22 relative to the printing system 10, the direction that a product 22 is moving, when a moving product 22 has been stopped, and when a product 22 is in the correct position to be printed upon. Suitable sensors 31 (described below) may include, but are not limited to, a speed sensor for detecting the speed and/or direction that a product 22 is moving and a location sensor for indicating when a product 22 is positioned in front of the sensor 31.

The printing system 10 includes a printing beam exit member 32 through which the printing beam 14 exits the housing 16. The printing beam exit member 32 can be as simple as an opening in the housing 16 or an immobile window mounted in the housing 16. In another configuration, the printing beam exit member 32 can be moved relative to the housing 16 as illustrated by the arrow labeled A. In this configuration, the printing beam 14 can be manually aimed toward a particular position on the material 20 by manipulating the printing beam exit member 32.

Because the laser can be a low power laser, the housing 16 can also be compact. For instance, the housing 16 can have a volume of less than 1200 cubic inches. In some instances, the housing 16 has a volume less than 900 cubic inches In other instances, the housing 16 has a volume less than 1200 inches. In one configuration, the housing 16 has a length, L, less than 25 inches, a width, W, less than 10 inches and a height, H, less than 5 inches. In another configuration, the housing 16 has a length, L, less than 23.5 inches, a width, W, less than 7.5 inches and a height, H, less than 4 inches. For purposes of these dimensions, the housing 16 may include the print beam exit member 32.

The small size is also associated with a low weight. For instances, in one configuration, the housing 16 and the enclosed components weighs less than 30 pounds. In some instances, the housing 16 and the enclosed components weigh less than 25 pounds and in other instances, the housing 16 and the enclosed components weigh less than 22 pounds. This weight does not include the weight of components which are remote from the housing 16. For instance, this weight does not include user interfaces 30 which are not integral to the housing 16. In addition, this weight does not include the weight of any sensors with which the printing system 10 is in communication but which are not integral with the housing 16.

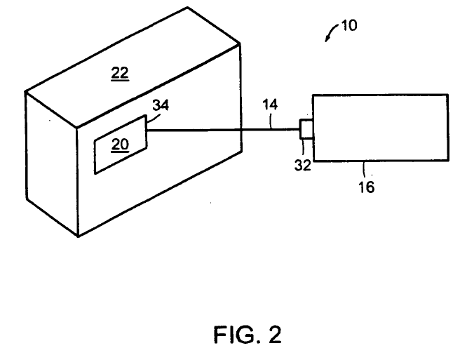

FIG. 2 illustrates an example of the printing system 10 forming a print zone 34 upon a product 22. The printing system 10 can include components for defining the print zone 34 on the material 20. For instance, the printing system 10 can project a rectangle onto the material 20 as illustrated in FIG. 2. The printing system 10 forms the symbol of the code within the print zone 34.

During operation of the printing system 10, the print zone 34 may be printed automatically or be controlled by an operator. The operator may adjust the beam outlet member 32 so that the print zone 34 is formed at a desired location on the material 20. The user interface 30 is then used to activate print within the print zone 34. As a result, the operator of the printing system 10 can select where the printing system 10 prints a code on the material 20 by ensuring that the print zone 34 appears in the desired print location. Suitable print zone marks may include, but are not limited to, marks at the four corners of a print zone 34, a mark positioned in the center of the print zone 34, and a dashed line around the print zone 34.

In one configuration of the printing system 10, the electronics 26 control the size and geometry of the print zone 34. As a result, the electronics 26 can match the size and shape of the symbols to be printed on the material 20. For example, when an unusually large code is to be printed on the material 20, the electronics 26 can enlarge the print zone 34 so the code will be formed entirely within the print zone 34. As a result, an increase in the size of the code will not result in erroneous positioning of the code on the material 20.

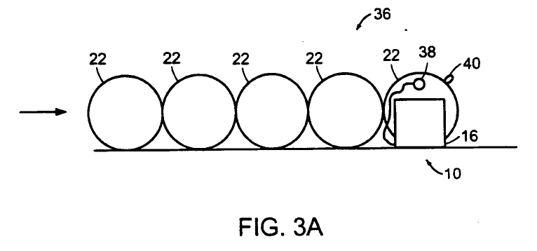

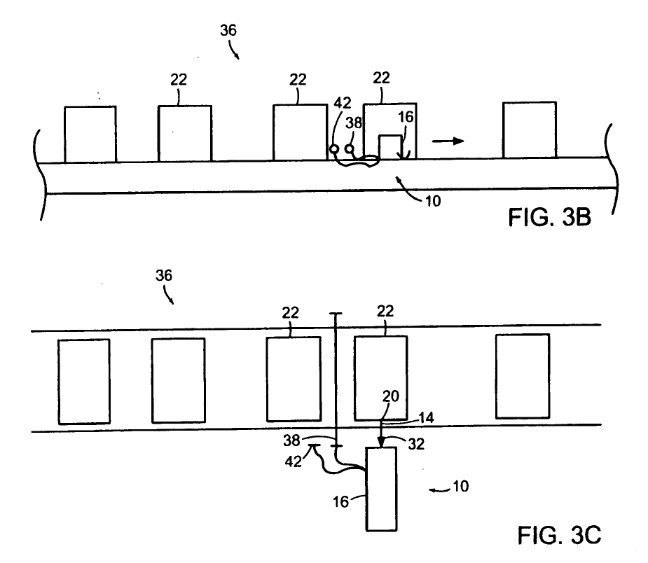

FIG. 3A illustrates a side view of the printing system 10 in operation with a product line 36 which temporarily stops the product 22 in front of the printing system 10. The printing system 10 can print on a stationary product 22 or on packaging located on a product line 36 which moves the product 22 relative to the printing system 10. The printing system 10 in FIG. 3A is in communication with a print trigger 38 which detects when one of the products 22 is positioned in front of the print trigger 38. A suitable print trigger 38 includes a device which produces a light beam. The device can be set up next to the product line 36 so that the product 22 disrupts the beam as the product 22 travels along the product line 36. The printing system 10 can monitor the device to determine when a product 22 has disrupted the beam. The print trigger 38 can be positioned such that when it has been triggered, the product 22 is correctly positioned for printing on the product 22. Alternatively, the print trigger 38 can be positioned such that when it has been triggered, a time delay will pass before the product 22 is correctly positioned for printing upon the product 22.

The printing system 10 is also in communication with a stop mechanism 40 which stops each product 22 in front of the printing system 10. During operation of the product line 36, the stop mechanism 40 is withdrawn to allow the products 22 to move along the product line 36. The movement can result from one or more mechanical forces or one or more natural forces such as gravity. Once the product 22 has moved past the stop mechanism 40, the stop mechanism 40 is moved back into place to block the next product 22.

During operation of the printing system 10 illustrated in FIG. 3A, the products 22 pass before the printing system 10 on the product line 36. The printing system 10 monitors the print trigger 38 to determine when a product 22 has moved in front of the print trigger 38. The printing system 10 waits a pre-set delay to let the product 22 be pressed against the stop mechanism 40 and then prints the symbols on the packaging. As a result, the product 22 remains stationary while the printing system 10 prints the code on the packaging.

Once the code has been printed, the printing system 10 activates the stop mechanism 40 so the product 22 is again able to move. The printing mechanism monitors the print trigger 38 to find a gap between products 22. Once a gap is found, the printing system 10 activates the stop mechanism 40 to stop the next product 22 and again monitors the print trigger 38 to detect when the next product 22 has moved in front of the print trigger 38.

FIGS. 3B and 3C illustrate the printing system 10 in use with a product line 36 which continuously moves the product 22 past the printing system 10. The products 22 can be evenly or sporadically spaced on the line. The printing system 10 is in communication with a print trigger 38 and a speed sensor 42. The electronics 26 (FIG. 1B) can use signals from the speed sensor 42 to determine the speed and direction of the products 22 on the product line 36. Suitable speed sensors include, but are not limited to, encoders and resolvers.

While setting up the printing system 10, the distance between the printing system 10 and the print trigger 38 is administratively entered into the electronics 26. In an alternative configuration, the print trigger 38 is attached to the housing 16 so as to provide a fixed and known distance between the print trigger 38 and the printing beam 14. In this configuration, the distance is known to the electronics 26 and does not need to be administratively entered.

During operation, the printing system 10 monitors the print trigger 38 to determine when a product 22 has moved in front of the print trigger 38. When it determines that a product 22 has moved in front of the print trigger 38, the printing system 10 determines the speed of the product 22 on the line 36 and uses this speed to determine a code position time delay. The code position time delay is determined such that the code is printed at a desired position on the product 22. A suitable method for determining this code position time delay is discussed below. Once the determined code position time delay has passed, the symbols are printed as the product 22 moves past the printing system 10.

Once the code is printed, the print trigger 38 is monitored to determine when the product 22 has moved past the print trigger 38. Once the product 22 moves past the print trigger 38, the printing system 10 returns to monitoring the print trigger 38 to identify when a new product 22 has moved in front of the print trigger 38. As is evident from FIG. 3B, the print trigger 38 can be triggered by one product 22 while printing on another product 22. Hence, the printing system 10 may track the time delay for one of the products 22 while printing on the other product 22. These situations can be handled with standard multi-task programming.

The printing system 10 can be used with other product lines 36. For instance, some product lines 36 include a labeling station for applying a label to a product 22. A labeling station typically includes electronics for determining when each product 22 has the label applied. The printing system 10 can be in communication with the labeling station and can print the code on each label after it has been applied to the product 22. The printing of the code can be triggered by the electronics within the label station. For instance, when the electronics of the label station detect that a label has been applied, these electronics can provide the printing system 10 with a signal indicating that the code should be printed.

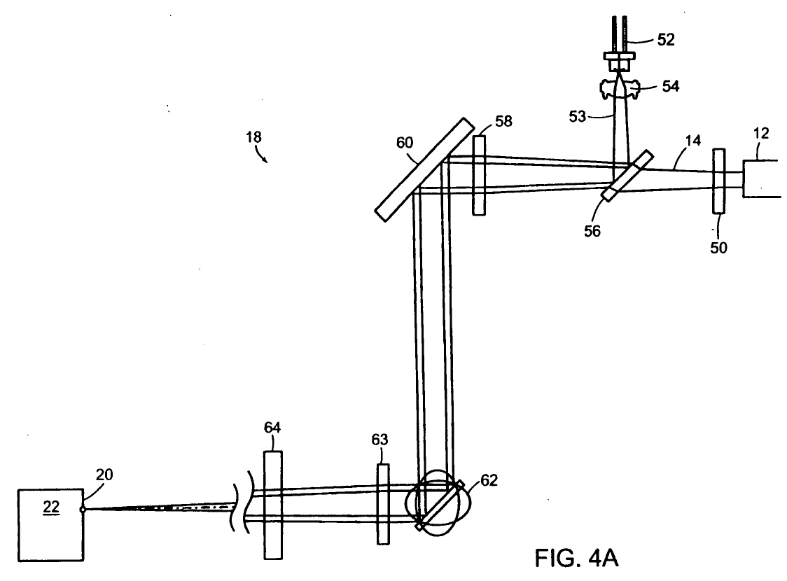

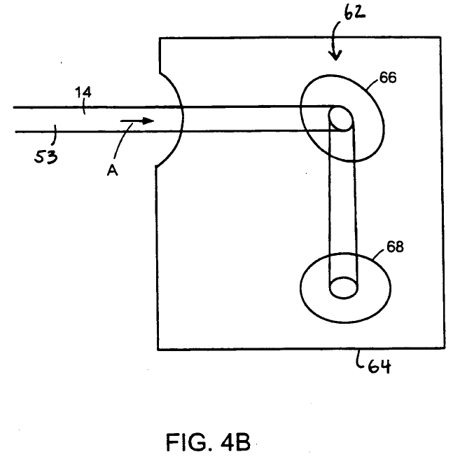

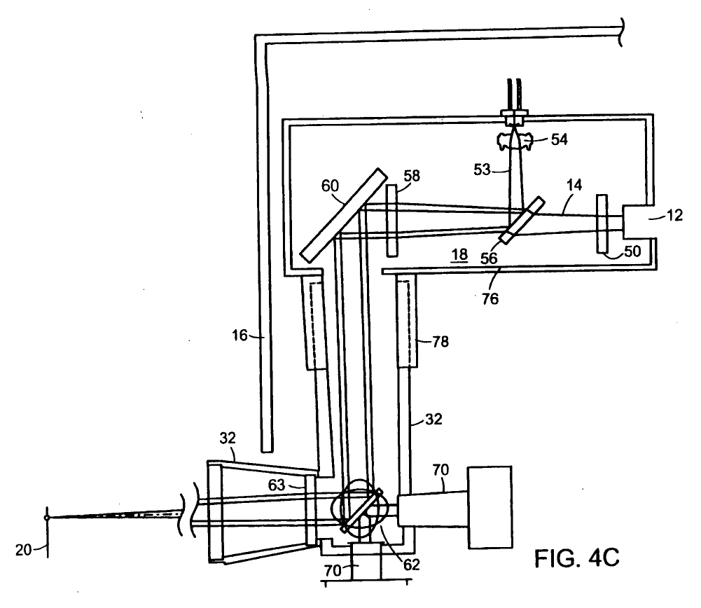

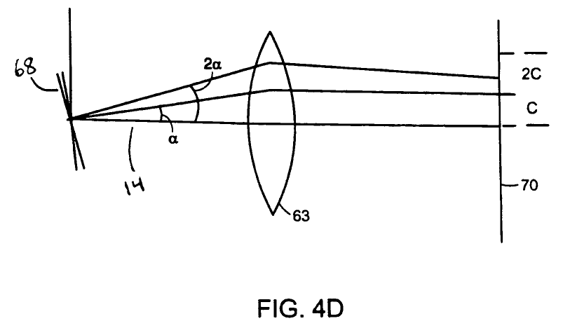

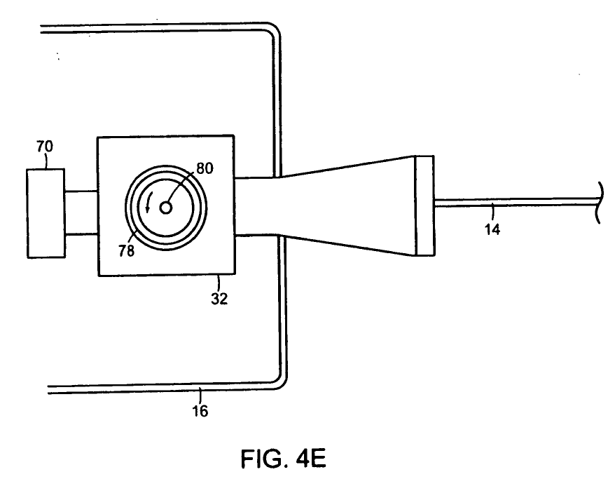

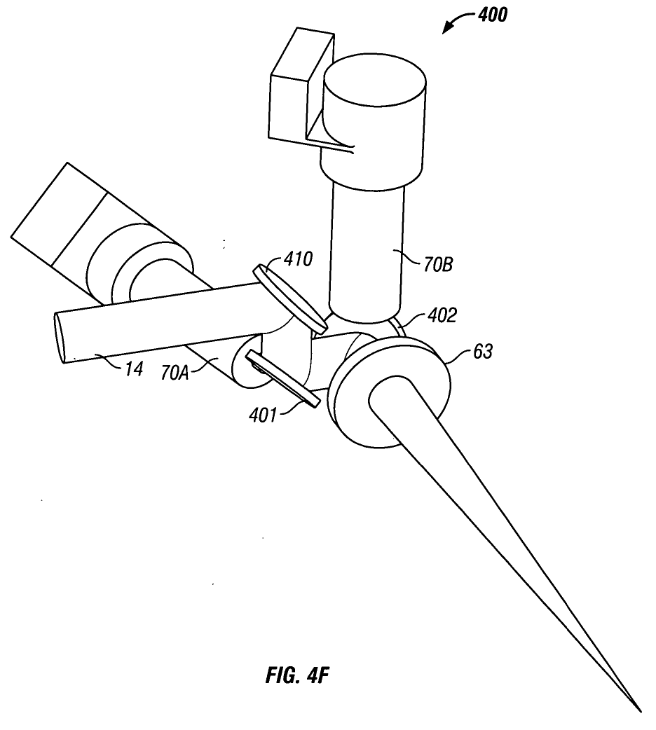

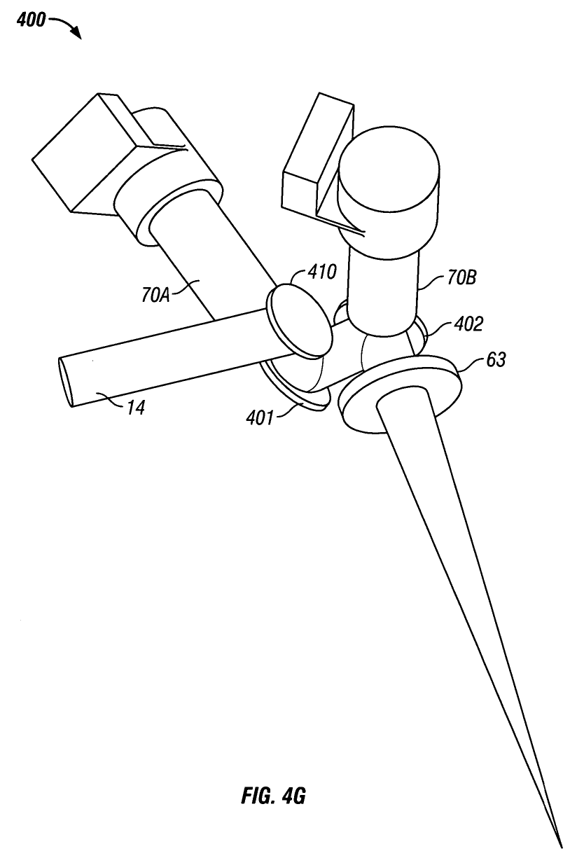

FIG. 4A illustrates a top view of an optics assembly 18 in the printing system 10. The optics assembly 18 includes the laser source 12 for producing the printing beam 14. The printing beam 14 passes through a first negative lens 50, which expands the printing beam 14. The optics assembly 18 also includes a print zone light source 52 for producing a print zone beam 53, which passes through a second negative lens 54, which expands the print zone beam 53. Although the printing beam 14 and the print zone beam 53 are illustrated as being concurrently produced, the electronics 26 (FIG. 1B) can cause them to be produced independent of one another. Further, the print zone beam 53 is optional and need not be included in the optics assembly 18.

The printing beam 14 and the print zone beam 53 are combined at a beam combiner 56. The combined beams pass through a positive lens 58, which collimates the beams before they are turned at a reflector 60. The combined beams then pass to a plurality of mirrors 62 which reflect the combined beams toward a second positive lens 63, which focuses the combined beams. The combined beams then pass through a protective window 64 before passing to the product 22.

Because FIG. 4A is a top view of the optics assembly 18, and the mirrors 62 are positioned on top of one another, the arrangement of the mirrors 62 is not apparent from FIG. 4A. In order to clarify the arrangement of the mirrors, FIG. 4B provides a side view of the optics assembly 18 looking through the protective window 64. The combined beams 14, 53 approach the mirrors 62 from the left as illustrated by the arrow labeled A. The beams 14, 53 are reflected off a first mirror 66 down toward second mirror 68. The combined beams 14, 53 are reflected from the second mirror 68 out of the page.

As illustrated in FIG. 4C, one or both of the mirrors 62 can be coupled with a one or more actuators 70 for moving the mirrors 62. Suitable actuators 70 may include micromotors. The actuators 70 are controlled by the electronics 26 (FIG. 1B) to steer the beams 14, 53 to form symbols and the print zone 34 on the packaging. For instance, when the print zone 34 has a rectangular shape, the print zone beam 53 can trace a rectangle around the print zone 34 at a speed which causes the rectangle to appear solid to the human eye or at about 100 cycles/second.

The second positive lens 63 of FIG. 4A can be a non-linear lens. FIG. 4D illustrates the second mirror 68 in a first position and a second position. In the first position, the angle between the printing beam 14 and a lens axis is α, while in the second position this angle is doubled to 2α. Due to the non-linear nature of the lens 63, the printing beam 14 is incident on the product 22 at a distance, C, from the lens axis when the second mirror 68 in the first position. However, when the second mirror 68 is in the second position, the printing beam 14 is not incident on the product 22 at a distance, 2C, from the lens axis despite the angle being increased to 2α. The lack of proportionality between the movement of the mirror 68 and the movement of the printing beam 14 results from the non-linear nature of the lens 63.

The electronics 26 (FIG. 1B) can include logic which corrects for the effects of non-linearity of the second positive lens 63. Accordingly, this logic would cause the second mirror 68 to increase the angle by more than 2α in order to move the printing beam 14 by 2C. The correction logic can be developed from theoretical optical equations providing a relationship between α and C for the second positive lens 63. Alternatively, the correction logic can be developed from experiments performed to determine the relationship between α and C. This correction logic eliminates the need for an expensive and large F-θ lens which is typically used to correct for non-linearity. Accordingly, this correction allows the size and cost of the printing system 10 to be reduced.

The effects of spherical aberration can be corrected with the variable dwell time. For instance, the dwell time may be increased when the effects of aberration are apparent on the product 22.

During operation of an optics assembly 18 including a printing zone light source 52, the print zone light source 52 is activated and the laser 12 is deactivated. The mirrors 62 are moved such that the print zone 34 is formed on the product 22. When the symbols are to be formed on the packaging, the print zone light source 52 is disengaged, and the laser/energy source 12 engaged until the symbols are formed. Once the symbols are formed, the laser/energy source 12 can be disengaged and the print zone light source 52 engaged in order to continue with formation of the print zone 34.

As discussed above with reference to FIG. 1B, the printing system 10 can include a printing beam exit member 32 which can be moved relative to the apparatus housing 16. FIGS. 4C and 4E illustrate the mechanical arrangement which permits this movement of the printing beam exit member 32. A frame 76 in FIG. 4C supports the printing beam exit member 32 within the housing 16. A bearing 78 positioned between the frame 76 and the printing beam exit member 32 allows the printing beam exit member 32 to move relative to the frame 76. FIG. 4E provides a cross-sectional side view of the bearing 78 looking along the printing beam 14. The printing beam 14 passes through the bearing 78 (FIGS. 4C and 4E) along the axis of rotation 80 permitted by the bearing 78 (FIG. 4E), is reflected by the mirrors 62 (FIG. 4C) and passes through the end of the exit member 32 (FIGS. 4C and 4E). Hence, movement of the printing beam exit member 32 relative to the frame 76 does not change the position of the printing beam 14 relative to the bearing 78.

As illustrated in FIGS. 4C and 4E, the mirrors 62 and the actuators 70 are coupled with the printing beam exit member 32. As a result, the mirrors 62 and the actuators 70 move with the printing beam exit member 32 as the printing beam exit member 32 is moved relative to the housing 16. Further, a portion of the first mirror 66 (FIG. 4B) is positioned along the bearing's axis of rotation 80 (FIG. 4E). Hence, movement of the printing beam exit member 32 does not alter the angle of incidence between the printing beam 14 and the first mirror 66. Accordingly, when the printing beam exit member 32 is moved relative to the housing 16, the first mirror 66 still directs the printing beam 14 toward the same portion of the second mirror 68, and the printing beam 14 still exits the housing 16 through the same portion of the protective window 64. The rotatability of the printing beam exit member 32 relative to the housing 16 allows the printing beam 14 transmitted through the printing beam exit member 32 to be aimed at various positions on the product 22.

Low Angle Optics

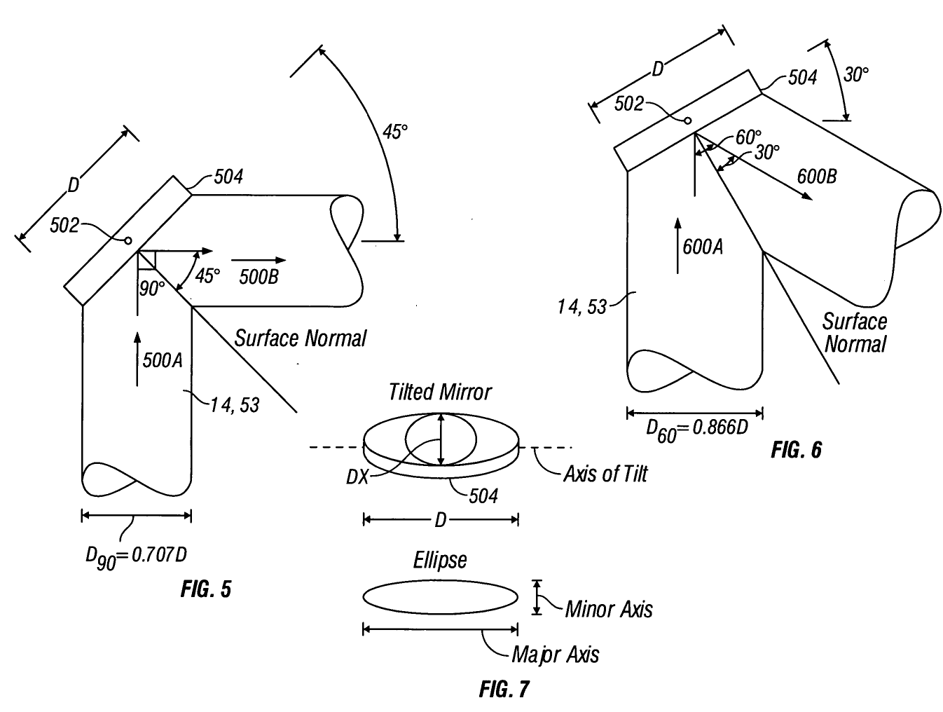

FIG. 5 illustrates a mirror 504, which represents each mirror 66, 68 in FIG. 4B. The mirror 504 is positioned to reflect an incident light beam 500A (the printing beam 14 and/or the print zone beam 53 in FIG. 4B) by 90 degrees to form a reflected beam 500B. In other words, an angle between the reflected beam 500B and the incident beam 500A is 90 degrees. The incident beam 500A and reflected beam 500B are each at a 45-degree angle with respect to the surface of the mirror 504. The incident beam 500A and reflected beam 500B are each at a 45-degree angle with respect to a surface normal of the mirror 504.

In FIG. 4B, the first mirror 66 reflects the printing beam 14 (and/or the print zone beam 53) ninety degrees down to the second mirror 68. The second mirror 68 reflects the printing beam 14 (and/or the print zone beam 53) ninety degrees out of the page to the second positive lens 63 and protective window 64 in FIG. 4A. The first and second mirrors 66, 68 may be described as “90-90 mirrors” or “orthogonal mirrors.”

The 90-degree angle between the incident beam 500A and reflected beams 500B is called a “nominal” angle (also called “starting” angle or “base” angle), which is a starting angle that changes as each mirror 66, 68 in FIG. 4B is tilted along an axis 502 (FIG. 5) by actuators 70 (FIG. 4C) to control printing along x and y directions to form spots on the product 22 (FIG. 1A), as described in further detail below. The actuators 70 may be controlled by the electronics 26 in FIG. 1B, which may include a controller or processor. For example, the first mirror 66 in FIG. 4B may be tilted about ±6 degrees, which causes the reflected beam 500B to be at an angle of 78 degrees to 102 (optical angle=2(mechanical angle due to reflection)) degrees with respect to the incident beam 500A. FIGS. 4F and 4G (described below) illustrate a different configuration than FIGS. 4B-4C, but FIGS. 4F and 4G are useful to show in three-dimensions how two actuators 70A, 70B control tilting of two mirrors 401, 402, which move a light beam. More than or less than 6 degrees may be used.

One aspect of the present application relates to “low angle optics,” which refers to positioning the mirrors 66, 68 to reflect the printing beam 14 (and/or the print zone beam 53) by nominal angles less than 90 degrees. For example, the mirrors 66, 68 may be tilted by the actuators 70 (FIG. 4C) or otherwise positioned to reflect an incident beam by nominal angles of 75 degrees, 60 degrees, 45 degrees or 30 degrees to form the reflected beam. The printing system 10 may use any suitable nominal angle less than 90 degrees between the incident beam and the reflected beam as long as the incident beam stays on the mirror 66, 68.

FIG. 6 illustrates a mirror 504, which represents a variation of at least one of the mirrors 66, 68 in FIG. 4B. The mirror 504 is positioned to reflect an incident light beam 600A (the printing beam 14 and/or the print zone beam 53) by 60 degrees to form a reflected beam 600B. The angle between the reflected beam 600B and the incident beam 600A is 60 degrees.

The printing system 10 (FIG. 1A) may use any combination of nominal angles of 90 degrees or less between the incident and reflected beams for the two mirrors 66, 68 in FIG. 4B. In one configuration, the first mirror 66 in FIG. 4B is positioned to have a nominal angle of 90 degrees between the incident and reflected beams (FIG. 5), and the second mirror 68 is positioned to have a nominal angle of 60 degrees between the incident and reflected beams (FIG. 6). In another configuration, the first mirror 66 in FIG. 4B is positioned to have a nominal angle of 90 degrees between the incident and reflected beams (FIG. 5), and the second mirror 68 is positioned to have a nominal angle of 75 degrees between the incident and reflected beams (FIG. 6). Other examples of the nominal angles for the first and second mirrors 66, 68 may be 60 degrees and 60 degrees, 60 degrees and 90 degrees, 75 degrees and 75 degrees, 75 degrees and 60 degrees, etc.

The diameter D of the mirror 504 in FIGS. 5 and 6 is a constant. D₉₀ is the maximum diameter of the incident beam 500A in FIG. 5. D₆₀ is the maximum diameter of the incident beam 600A in FIG. 6. The 60-degree nominal angle in FIG. 6 exposes more surface area of the mirror 504 to the incident light beam 600A than the 90-degree nominal angle in FIG. 5. The larger exposed surface area of the mirror 504 in FIG. 6 allows the maximum diameter D₆₀ of the incident beam 600A to be larger than the maximum diameter D₉₀ of the incident beam 500A in FIG. 5. D₆₀ and D₉₀ is equal to D multiplied by the cosine of an angle between a surface normal of the mirror 504 and the angle of reflection. For example, D₆₀ is equal to D×cosine(30 degrees)≅0.866×D. D₉₀ is equal to D×cosine(45 degrees)≦0.707×D. Thus, the mirror 504 in FIG. 5 positioned with its 90-degree nominal angle limits an incident beam's maximum diameter D₉₀ to about 71% of the mirror's diameter D. The mirror 504 in FIG. 6 positioned with its 60-degree nominal angle allows an incident beam's maximum diameter D₆₀ to be about 87% of the mirror's diameter D. The mirror 504 tilted at a 60-degree nominal angle in FIG. 6 enables the printing system 10 to use a laser beam (from laser 12 in FIG. 4A) with a larger diameter.

Since the mirrors 66, 68 in FIG. 4B are tilted, e.g., ±6 degrees, by the actuators 70 (FIGS. 4C and 4F) to move a light beam in x and y directions, the printing system 10 should use a light beam with a diameter less than the maximum diameter (D₉₀ in FIG. 5 or D₆₀ in FIG. 6) to prevent the incident light beam 500A or 600A from falling off the mirror 66, 68, as explained below with reference to FIG. 7.

FIG. 7 illustrates an example of a tilted circular mirror 504 (representing one of the mirrors 66, 68 in FIG. 4B) with a diameter D and a circular light beam (coming from out of the page and reflecting up off the mirror 504) with a diameter DX. As the circular mirror 504 tilts, the mirror 504 forms an ellipse with a major axis and a minor axis. The major axis length is equal to the diameter D of the mirror 504. The minor axis length decreases as the mirror 504 tilts from 0 to 90 degrees. The incident light beam's diameter DX should be equal to or less than the minor axis length (which is less than the major axis length D) to prevent the light beam from falling off the tilted mirror 702. Thus, the incident light beam's maximum diameter DX is limited to an exposed surface area of the tilted mirror 702, which depends on the amount of tilt of the mirror 702.

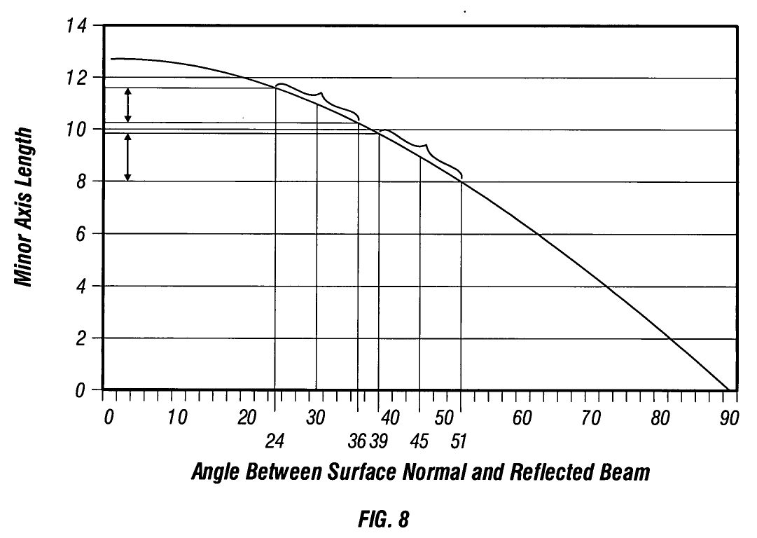

FIG. 8 illustrates a graph of a minor axis length (FIG. 7) versus the 30-degree and 45-degree angles between the surface normal and the reflected beams 500B, 600B in FIGS. 5 and 6, respectively. The maximum value of the minor axis length in FIG. 8 (which is equal to the diameter of the mirror 504) is 12.7 inches, for example. As shown in FIG. 8, the 30-degree angle between the surface normal and the reflected beam 600B in FIG. 6 corresponds to a larger minor axis length (10.999) than the 45-degree angle between the surface normal and the reflected beam 500B in FIG. 5. Thus, the mirror 504 tilted at a less-than-90-degree nominal angle (e.g., 60-degree nominal angle in FIG. 6) has a larger exposed surface area, which enables the printing system 10 to use a larger diameter laser than the mirror 504 tilted at a 90-degree nominal angle in FIG. 5.

The 30-degree and 45-degree angles in FIG. 8 may vary between a range of ±6 degrees as the mirrors 504 in FIGS. 5 and 6 tilt by ±6. As the mirrors 504 tilt by ±6 degrees, the minor axis length varies. Since the shape of curve in FIG. 8 is a cosine curve, the slope of the curve at 60 degrees is shallower leading to a small change in minor axis length as the mirror 504 in FIG. 6 tilts by ±6, which is less than the change in minor axis length as the mirror 504 in FIG. 5 tilts by ±6 due to the steeper slope of the curve at 45 degrees.

As stated above, a mirror 504 tilted at a less-than-90-degree nominal angle (e.g., 60-degree nominal angle in FIG. 6) enables the printing system 10 to use a larger diameter laser beam than the mirror 504 tilted at a 90-degree nominal angle in FIG. 5. A laser beam (from laser 12 in FIG. 4A) with a larger diameter Dlaser provides a smaller spot size diameter (spot formed on the product 22 in FIG. 1A). Spot size diameter may be expressed as:
spot size diameter=(4M²λf)/(π)(Dlaser)
where M indicates a quality of a laser (e.g., M²=1.2), λ is the wavelength of the laser beam (e.g., 10.6×10⁻⁶ meters for a CO₂ laser), f is the focal length (e.g., 6 inches), and Dlaser is the diameter of the laser beam (e.g., 0.011 meters or 7.5 mm). As an example, spot size diameter may be about 224 micrometers. As shown in the equation above, increasing the laser beam diameter Dlaser will decrease spot size diameter.

A smaller spot size provides a higher power density, which may be expressed as:
power density=(power of laser)/(area of spot)=(power of laser)/(π/4)(spot diameter)²

As shown in the equation above, decreasing spot size diameter will increase power density and fluence. “Fluence” may be expressed as:
fluence=(power)(time)/(area of spot)

Higher fluence allows the printing system 10 (FIG. 1A) to more easily mark a product 10 and be able to mark more types of product or packaging materials. A smaller spot area allows the printing system 10 to use a smaller dwell time to achieve the same fluence.

In summary, the less-than-90-degree angle (e.g., 60 degrees) between incident and reflected beams may (a) allow the printing system 10 to use a larger laser diameter and a smaller spot size, (b) allow more working room on each mirror 66, 68 (i.e., more room or tolerance for alignment errors) with the same laser diameter size used for 90-90 mirrors, or (c) allow the printing system 10 to use a smaller mirror than a mirror with a 90-degree nominal angle between incident beam and reflected beam.

Smaller mirrors in the printing system 10 (FIG. 1A) may have several advantages. Smaller mirrors need less material and may be less expensive to manufacture. Smaller mirrors may be easier and faster to tilt in the optics assembly 18 in FIGS. 4A and 4C. Larger mirrors may require more inertia to move than smaller mirrors. The printing system 10 may use smaller, less complex components, such as actuators or micromotors, to move smaller mirrors. Smaller mirrors may fit in a smaller space of the printing system 10 and allow the overall size of the printing system 10 to be smaller.

Reversed Optics

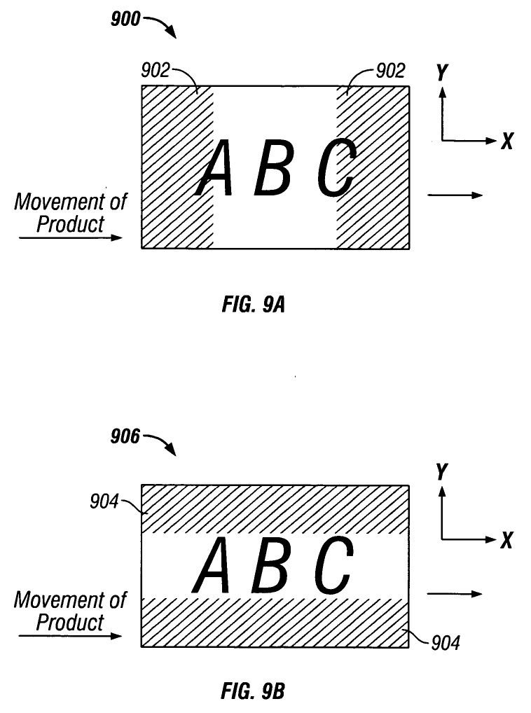

The first mirror 66 in FIG. 4B controls scanning of the printing beam 14 (and print zone beam 53) in the x-direction (horizontal, i.e., left and right), and the second mirror 68 controls scanning of the printing beam 14 in the y-direction (vertical, i.e., up and down) to print a code of pixels on the product 22. A portion of the printing beam 14 may fall off the second mirror 68, which controls the y-direction, and result in lower power printing along first and last edges of a printed image 900, as shown in FIG. 9A. FIG. 9A illustrates an example of a printed image 900 (or print zone 34 as in FIG. 2) on a product moving left to right where a second mirror 68 controls y-direction scanning. The blurred portions 902 may be exaggerated for purposes of illustration. The printing system 10 may not be able to print sooner because of a limited aperture size. Portions of the first and last symbols “A” and “C” may be lost due to a portion of the printing beam 14 falling off the second mirror 68.

A second aspect of the application relates to “reversed optics,” which refers to a first mirror positioned to control the printing beam 14 in the y-direction, and a second mirror positioned to control the printing beam 14 in the x-direction, as shown in FIGS. 4F-4G.

FIGS. 4F and 4G illustrate another configuration of the mirrors 66, 68 in FIG. 4B. In FIGS. 4F and 4G, the first mirror 401 is positioned to control the printing beam 14 in the y-direction (vertical), and the second mirror 402 is positioned to control the printing beam 14 in the x-direction (horizontal). FIGS. 4F and 4G also illustrate a folding mirror 410, the second positive lens 63 of FIG. 4A, and actuators 70A, 70B which control movement of the mirrors 401, 402. In one configuration, the actuator 70A rotates the first mirror 401 to provide ±2.75 degrees y-direction scanning, and the actuator 70B rotates the second mirror 402 to provide ±6 degrees x-direction scanning.

One way to reconfigure the mirrors 62 in FIG. 4B is to rotate the position of some or all of the components in the optics assembly 18 in FIG. 4A, except the horizontal laser 12. The folding mirror 410 allows the laser 12 (FIG. 4A) to be mounted horizontally since the folding mirror 410 reflects a horizontal incident beam down to the first mirror 401.

A portion of the printing beam 14 may fall off the second mirror 68, which controls the x-direction, and result in lower power printing along top and bottom edges of a printed image 906, as shown in FIG. 9B.

FIG. 9B illustrates an example of a printed image 906 (or print zone 34 as in FIG. 2) on a product moving left to right where a second mirror 68 controls x-direction scanning. As shown in FIG. 9B, the top and bottom blurred portions 904 do not affect the symbols. This configuration of the mirrors 401, 402 may provide more horizontal space to print and allow the printing system 10 to print sooner in the print zone 34 (FIG. 2).

Spots, Pixels and Symbols

As described above, the printing beam 14 forms a plurality of spots at a variety of locations on the product 22 by remaining at the location until an optical characteristic of the location is altered. For illustrative purposes, FIGS. 10A-10D illustrate formation of a spot on a product 22 by removing a layer of ink from the product 22. FIGS. 10A and 10B illustrate the printing beam 14 incident on the material 20 at a particular location before a spot 83 (FIG. 10C) is formed on the material 20. The material 20 includes a substrate 82 such as paper. An ink layer 84 is formed on the substrate 82. The ink layer 84 can include several different ink types as well as several different colors as is apparent from the labels of many commercially available products 22. The material 20 illustrated in FIG. 10A includes an additional layer 86. The additional layer 86 represents the one or more layers which are often present over the ink layer 84 on product packaging. For instance, many materials 20, such as dog food bags, include a wax layer over the substrate 82 and ink layers 84.

FIGS. 10C-10D illustrate the material 20 after the spot 83 has been formed at the particular location on the material 20. The time that the printing beam 14 dwells at the particular location is adjusted such that the printing beam 14 has ablated the ink layer 84 and the additional layer 86 from the material 20 without burning the substrate 82. As a result, the substrate 82 is seen at the particular location on the material 20. The time to ablate an ink layer 84 is typically 100-500 μs.

The time to form the spot 83 is often a function of the materials 20 in the layers. For instance, the additional layer 86 can be a wax layer which protects the packaging and gives it an attractive appearance. Forming a spot 83 through such layers often requires more time than is required by the ink layer 84 alone.

The time that the printing beam 14 dwells at a location may be adjusted such that a spot is formed at the location. In some instances, the dwell time is greater than 50 μs, such as 100 μs, 200 μs, 50-50,000 μs, 100-500 μs or 200-500 μs. In some instances, the diameter of the spot is less than 400 μm, less than 250 μm or less than 170 μm.

FIG. 11A illustrates a plurality of spots 83 arranged on the material 20 (FIG. 10A) so as to define a pixel 88 on the material 20. Moving the printing beam 14 from one location to another location as illustrated by the arrow labeled A creates the pixel 88. A spot 83 is created at each location. The printing beam 14 is preferably incident on the material 20 throughout the formation of the pixel 88. The printing beam 14 is preferably moved from between locations where spots 83 are to be formed at a speed which prevents ablation of any of the layers on the material 20 between spots 83. This is possible due to the relatively low power of the laser 12. As a result, marks are not formed on the material 20 between the spots 83. Alternatively, the printing beam 14 can be moved from one location to another slow enough to provide some ablation between the spots 83. The additional ablation can help create the appearance of continuity between the spots 83.

The size of the pixels 88 formed by the printing system 10 can be selected as illustrated in FIG. 11B-11D. Increasing the number of spots 83 used to create the pixel 88 can increase the size of a pixel 88. For a given energy source power and spot size, there is a tradeoff between the time needed to create a pixel 88 and the pixel size. Hence, when an increased printing time is needed, the pixel size can be reduced. Further, the pixels 88 illustrated above have a hexagonal shape, the spots 83 can be arranged in a pixel 88 having a shape other than hexagonal. For instance, the pixels 88 can be square, triangular, circular, etc. In one embodiment, the operator of the printing system 10 can use the user interface 30 (FIG. 1A) to select the size and shape of the pixel 88.

FIG. 12A illustrates an array of possible pixels 88 arranged in 5 columns and 5 rows. Symbols can be formed in the array by selecting certain of the possible pixels 88 to become a pixel 88 of a symbol while not selecting other of the pixels 88. For instance, a “T” is formed by selecting the possible pixels 88 which are darkened in FIG. 12A. The printing system 10 (FIG. 1A) creates the symbol on the product 22 by directing the printing beam 14 so as to create pixels 88 on the product 22 in the pattern selected from among the possible pixels 88 in the array. Accordingly, the symbol appears on the product 22 as illustrated in FIG. 12B. The creation of symbols from a limited number of possible pixels 88 is well known as is illustrated by generation of characters on the LCD display of a calculator or traditional scoreboards.

Although the array of FIG. 12A is illustrated as having circular pixels 88, the array can include pixels 88 of different shapes such as squares. The distance between the pixels 88 can also be adjusted to increase or decrease the size of the code. In some instances, the distance between the pixels 88 is reduced to the point that the perimeter of one pixel 88 abuts the perimeter of another pixel 88. When the pixel 88 perimeters abut one another and the pixels 88 have a square shape, the symbols of the code can have a solid and continuous appearance.

Although the illustrated array is a 5×5 array, other array dimensions are possible. For instance, 5×5, 7×5 and 16×10 are preferred array dimensions. Further, the array need not be arranged in rows and columns. In addition, the possible pixels 88 in an array can overlap. Further, some pixels 88 can have a different size than other pixels 88. In addition, the array size can be changed to meet printing time requirements. For instance, when a code to be printed is so large that the system 10 (FIG. 1A) is not able to print the code on a moving product 22 within the time that the product 22 occupies a position in which the code can be printed, the array size may be reduced in order to reduce the number of pixels that are printed by the system 10. Because the system 10 has to print fewer pixels, the time needed to print the code is reduced. Accordingly, an embodiment of the application includes electronics for changing the pixel density in an alphanumeric code to be printed on a moving product.

The electronics 26 of FIG. 1B can include a database which associates each symbol with a particular pixel pattern. As a result, the operator can enter a symbol or symbol sequence into the user interface 30 and the printing system 10 consults the database to determine the pixel pattern associated with each symbol. The electronics 26 can use the pixel pattern of each symbol to form a first data set which indicates the position of each pixel 88 in a code. For instance, each pixel 88 can be associated with a Cartesian coordinate which indicates where the pixels 88 are to be printed relative to one another. Other coordinate systems and methods can also be used to control the relative positioning of the pixels 88 in a symbol.

Because the laser 12 used is preferably a low power laser, the laser 12 can be moved between pixels 88 without making any marks on the material 20 between the pixels 88. Hence, the laser 12 can also be moved between the symbols without marking portions of material 20 between the symbols. As a result, there is no need to disrupt the printing beam 14 while moving the printing beam 14 between pixels 88 and/or symbols. Typical methods for disrupting the printing beam 14 include turning off the laser 12 or positioning an opaque object in the printing beam 14. The disrupting methods may require synchronizing the printing beam disruption with both the motion of the printing beam 14 and any motion of the product 22. A printing system 10 according to the present application may overcome these difficulties.

Although number of aspects have been described, it should be understood that various changes, combinations, substitutions and alterations may be made hereto without departing from the spirit and scope of the application as described by the appended claims. Accordingly, other aspects are within the scope of the following claims.

1. A method for printing a spot on an object, the method comprising:
reflecting an incident light beam by a starting angle of less than ninety degrees to form a first reflected light beam;
varying the starting angle of reflection of the first reflected light beam by a pre-determined amount;
reflecting the first reflected light beam to form a second reflected beam;
varying an angle of reflection of the second reflected light beam; and
directing the second reflected beam to form a spot on an object.

2. The method of claim 1, further comprising forming a plurality of spots to print a pixel on the object.

3. A method for printing a spot on an object, the method comprising:
reflecting an incident light beam to form a first reflected light beam;
varying an angle of reflection of the first reflected light beam by a predetermined amount;
reflecting the first reflected light beam by a starting angle of less than ninety degrees to form a second reflected beam;
varying the starting angle of reflection of the second reflected light beam; and
directing the second reflected beam to form a spot on an object.

4. A system comprising:
a first mirror;
a first actuator attached to the first mirror;
a second mirror;
a second actuator attached to the second mirror; and
a controller coupled to the first and second actuators, the controller controlling the first actuator to cause the first mirror to reflect an incident light beam by a starting angle of less than ninety degrees to form a first reflected light beam, the first actuator being operable to tilt the first mirror and vary the starting angle of reflection of the first reflected light beam by a predetermined amount, the controller controlling the second actuator to cause the second mirror to reflect the first reflected light beam to form a second reflected beam, the second mirror directing the second reflected beam to form a spot on an object, the second actuator being operable to tilt the second mirror and vary an angle of reflection of the second reflected light beam by a pre-determined amount.

5. The system of claim 4, wherein the second mirror reflects the first reflected light beam by less than ninety degrees to form the second reflected beam.

6. The system of claim 4, wherein the first mirror reflects the incident light beam by sixty degrees to form the first reflected beam.

7. The system of claim 4, wherein the second mirror reflects the first reflected light beam by sixty degrees to form the second reflected beam.

8. The system of claim 4, wherein the first actuator and the first mirror control printing by the second reflected beam in a vertical direction on the object.

9. The system of claim 4, wherein the second actuator and the second mirror control printing by the second reflected beam in a horizontal direction on the object.

10. The system of claim 4, wherein the first actuator is operable to tilt the first mirror and vary an angle of reflection of the first reflected light beam by less than 10 degrees.

11. The system of claim 4, wherein the second actuator is operable to tilt the second mirror and vary an angle of reflection of the second reflected light beam by less than 10 degrees.

12. The system of claim 4, wherein second reflected light beam is configured to alter an optical characteristic of a spot on the object.

13. The system of claim 4, wherein second reflected light beam comprises a printing beam and a print zone beam, the printing beam forming symbols on the object, the print zone beam outlining a visually observable zone of printing on the object.

14. The system of claim 4, further comprising electronics to control the actuators to move the first and second mirrors such that the second reflected beam is directed to a plurality locations on the object.

15. The system of claim 4, wherein the actuators move the first and second mirrors to direct the second reflected beam to form at least one alphanumeric symbol on the object.

16. The system of claim 4, further comprising a 10-watt laser to form the incident light beam.

17. A system comprising:
a first mirror;
a first actuator attached to the first mirror;
a second mirror;
a second actuator attached to the second mirror; and
a controller coupled to the first and second actuators, the controller controlling the first actuator to cause the first mirror to reflect an incident light beam to form a first reflected light beam, the first actuator being operable to tilt the first mirror and vary an angle of reflection of the first reflected light beam by a predetermined amount, the controller controlling the second actuator to cause the second mirror to reflect the first reflected light beam by a starting angle of less than ninety degrees to form a second reflected beam, the second mirror directing the second reflected beam to form a spot on an object, the second actuator being operable to tilt the second mirror and vary an angle of reflection of the second reflected light beam by a pre-determined amount.

18. A system comprising:
a first mirror to reflect an incident light beam to form a first reflected light beam;
a first actuator attached to the first mirror, the first actuator being operable to tilt the first mirror and vary an angle of reflection of the first reflected light beam, wherein the first actuator and the first mirror control scanning by the second reflected beam in a direction perpendicular relative to a direction of movement of an object;
a second mirror to reflect the first reflected light beam to form a second reflected beam, the second mirror directing the second reflected beam toward an object; and
a second actuator attached to the second mirror, the second actuator being operable to tilt the second mirror and vary an angle of reflection of the second reflected light beam, wherein the second actuator and the second mirror control scanning by the second reflected beam in a direction parallel relative to direction of movement of the object.

19. A method comprising:
reflecting an incident light beam to form a first reflected light beam;
varying an angle of reflection of the first reflected light beam to control scanning by the second reflected beam in a direction perpendicular relative to a direction of movement of an object;
reflecting the first reflected light beam to form a second reflected beam toward the object;
varying an angle of reflection of the second reflected light beam to control scanning by the second reflected beam in a direction parallel relative to direction of movement of the object.
